(19) United States
(12) Patent Application Publication
(10) Pub. No.: US 2005/0022015 A1
(43) Pub. Date: Jan. 27, 2005

(54) Conditonal access system

(76) Inventors: Sebastiaan A F A Van Den Heuvel, Eindhoven (NL); Petrus Johannes Lenoir, Eindhoven (NL); Franciscus Lucas Antonius Johannes Kamperman, Eindhoven (NL)

Correspondence Address: Philips Electronics North America Corporation;Corporate Patent Counsel, PO Box 3001, Briarcliff Manor, NY, 10510, US

(21) Appl. No.: 10/496,480

(22) PCT Filed: Nov. 14, 2002
(86) PCT No.: PCT/IB02/04803

(30) Foreign Application Priority Data
Nov. 27, 2001 (EP) 01204668.6

(51) Int. Cl. H04L 9/00

(52) U.S. Cl. 713/201

(57) ABSTRACT

A conditional access system comprising a plurality of devices interconnected in a network, the devices being grouped in a first group and a second group, the devices of the first group operating in accordance with a first security framework and the devices of the second group operating in accordance with a second security framework, each device operating using a particular middleware layer, said middleware layer being arranged to authenticate another middleware layer of another device, said middleware layer being authenticated by the security framework in accordance with which the device operates.

### INTRODUCTION TO THE INVENTION

A typical digital home network includes a number of devices, e.g. a radio receiver, a tuner/decoder, a CD player, a pair of speakers, a television, a VCR, a tape deck, and so on. These devices are usually interconnected to allow one device, e.g. the television, to control another, e.g. the VCR. One device, such as e.g. the tuner/decoder or a set-top box (STB), is usually the central device, providing central control over the others. Control buttons and switches are usually located on the front of the tuner as well as on a handheld remote control unit. A user can control all devices by means of the central device or the remote control unit.

As these devices have become more versatile and more complex, simple manual control is no longer sufficient. Furthermore, as more and more devices become available, interoperability starts to become a problem. Many vendors use their own communication protocols to allow their devices to interact, but devices from different vendors cannot interact. To overcome these problems, several interoperability standards have been defined, which allow different devices to exchange messages and information and to control each other. One well-known standard is the Home Audio/Video Interoperability (HAVi) standard, version 1.0 of which was published in January 2000, and which is available on the Internet at the address http://www.havi.org/. Other well-known standards are the domestic digital bus (D2B) standard, a communications protocol described in IEC 1030 and Universal Plug and Play (http://www.upnp.org).

In a system according to such a standard, devices are interconnected in a network using a standard bus, e.g. an IEEE 1394 serial communication bus, and exchange information, such as messages, data and commands, over this network according to the standard. Standards such as HAVi define the protocol for such exchanges, allowing devices from different vendors to interact. Users can add new devices to the network, and they immediately become available to other devices. The protocol for “discovering” such a new device is also standardized.

Some of the devices in the in-home digital network (IHDN) may have an external connection. Using this connection, content can enter the network using broadband transmission or by being downloaded from the Internet. Content can also enter the network by reading it from a storage medium such as a Digital Versatile Disc (DVD) or a hard disk.

A challenge addressed by the solution presented in this document is how to realize secure transfer of content over this system while maintaining end-to-end control and without introducing large amounts of complexity.

### BRIEF DESCRIPTION OF THE INVENTION

According to a second aspect of the invention there is provided a conditional access system comprising a plurality of devices interconnected in a network, the devices being grouped in a first group and a second group, the devices of the first group operating in accordance with a first security framework and the devices of the second group operating in accordance with a second security framework, each device operating using a particular middleware layer, said middleware layer being arranged to authenticate another middleware layer of another device, said middleware layer being authenticated by the security framework in accordance with which the device operates.

All devices in the network implement a security framework. Using this framework, these devices can authenticate each other and distribute content securely and access to the content is managed by the security system. This prevents the unprotected content from “escaping” to unauthorized devices. For this to work, the devices must be able to trust each others' and their own middleware layer and the other devices' security framework. The invention prevents that a security framework has to authenticate each middleware layer in the system and has to support all kinds of middleware specifics for all the various middleware layers.

In an embodiment a device from the first group can execute a function of the second security framework by making a remote procedure call (RPC) to the middleware layer of a device from the second group. This embodiment allows security frameworks to locate each other and communicate and is independent of HN-MW and network technology.

In a further embodiment the RPC is transmitted to the device from the second group over a secure authenticated channel (SAC). This allows security frameworks that want to communicate with each other to do this securely. When several security devices are present in a network, the set of SACs between them can be seen as a virtual private network (VPN).

In a further embodiment the devices are granted permission to access content in accordance with a particular class of purposes, there being defined a set of such classes, each class comprising a number of conditional access operations or purposes. The middleware will treat the content of this content access within the scope of the class.

Preferably a first class from the set comprises the operations RENDER, MOVE and COPY. Further preferably a second class from the set comprises the operations STORE, RENDER, EDIT, DELETE and PROCESS. In a further embodiment the PROCESS operation is preferably authorized independent of any restrictions on rights associated with the content. The PROCESS operation allows compliant devices in the network access to protected content to perform operations that do not change the rights on the content without changing the rigths. Examples of such operations are content and bitrate transcoding, processing required to support trick play, picture improvement.

According to a second aspect of the invention there is provided a method of allowing a device to conditionally access a piece of content, in which the device is granted permission to access content in accordance with a particular class of purposes, there being defined a set of such classes, each class comprising a number of conditional access operations or purposes.

In an embodiment a first class from the set comprises the operations STORE, RENDER, EDIT, DELETE and PROCESS. In a further embodiment the PROCESS operation is authorized independent of any restrictions on rights associated with the content.

### BRIEF DESCRIPTION OF THE FIGURES

These and other aspects of the invention will be apparent from and elucidated with reference to the illustrative embodiments shown in the drawings, in which:

FIG. 1 schematically illustrates a preferred layout of an in-home network according to the invention, comprising a source, a sink, and two storage media;

FIG. 2 illustrates the basic structure of a preferred security framework for Rights Management & Protection (RMP);

FIG. 3 describes a message sent from one security framework to another;

FIG. 4 illustrates how calls are made using RPC calls on a public interface of a OPIMA OVMs;

FIG. 5 illustrates how to realize distributed content access; and

FIG. 6 illustrates how RPC calls are preferably managed.

Throughout the figures, same reference numerals indicate similar or corresponding features. Some of the features indicated in the drawings are typically implemented in software, and as such represent software entities, such as software modules or objects.

### IN-HOME NETWORK ARCHITECTURE

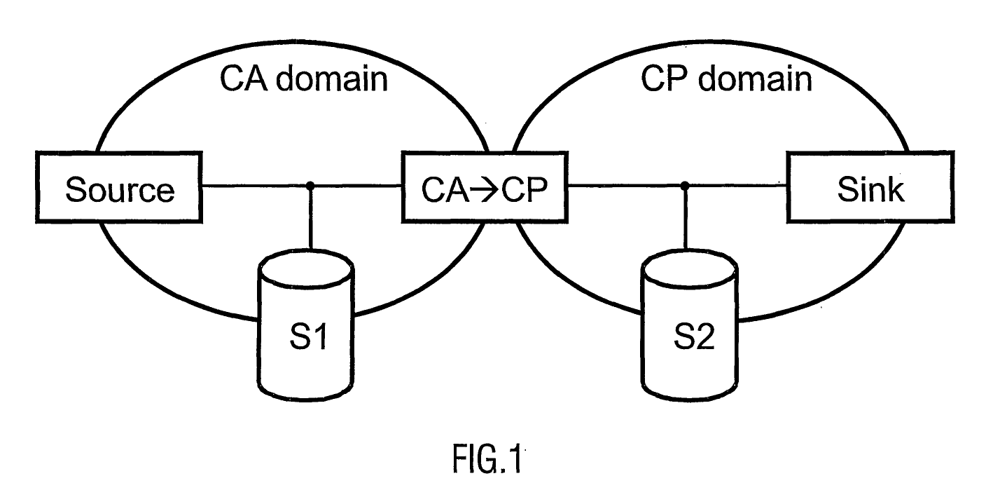

FIG. 1 schematically illustrates a preferred layout of an in-home network according to the invention, comprising a source, a sink, and two storage media S1 and S2. The network is divided conceptually in a conditional access (CA) domain and a copy protection (CP) domain.

Most content, which typically comprises things like music, songs, movies, TV programs, pictures and the likes, enters the in-home network in the CA domain. The source could be a connection to a broadband cable network, an Internet connection, a satellite downlink and so on. Content received in this fashion can be stored in the storage medium S1, so that it can be read out and rendered on a sink later on. The storage medium S1 could be a Personal Digital Recorder (PDR) of some kind, for example a DVD+RW recorder. A source can also be a DVD player in which a DVD disc is inserted, so that content can be read from the disc.

The exact way in which a content item is rendered depends on the type of sink and the type of content. For instance, in a radio receiver, rendering comprises generating audio signals and feeding them to loudspeakers. For a television receiver, rendering comprises generating audio and video signals and feeding those to a display screen and loudspeakers. For other types of content a similar appropriate action must be taken. Rendering may also include operations such as decrypting or descrambling a received signal, synchronizing audio and video signals and so on.

A sink can be, for instance, a television system or an audio playback device. Typically, the sink is located in the CP domain. This ensures that when content is provided to the sink, no unauthorized copies of the content can be made because of the copy protection scheme in place in the CP domain. The CP domain comprises storage medium S2, on which (temporary) copies of the content can be stored in accordance with the copy protection rules.

All devices in the in-home network that implement the security framework do so in accordance with the implementation requirements. Using this framework, these devices can authenticate each other and distribute content securely and access to the content is managed by the security system. This prevents the unprotected content from “escaping” to unauthorized devices.

Security Framework

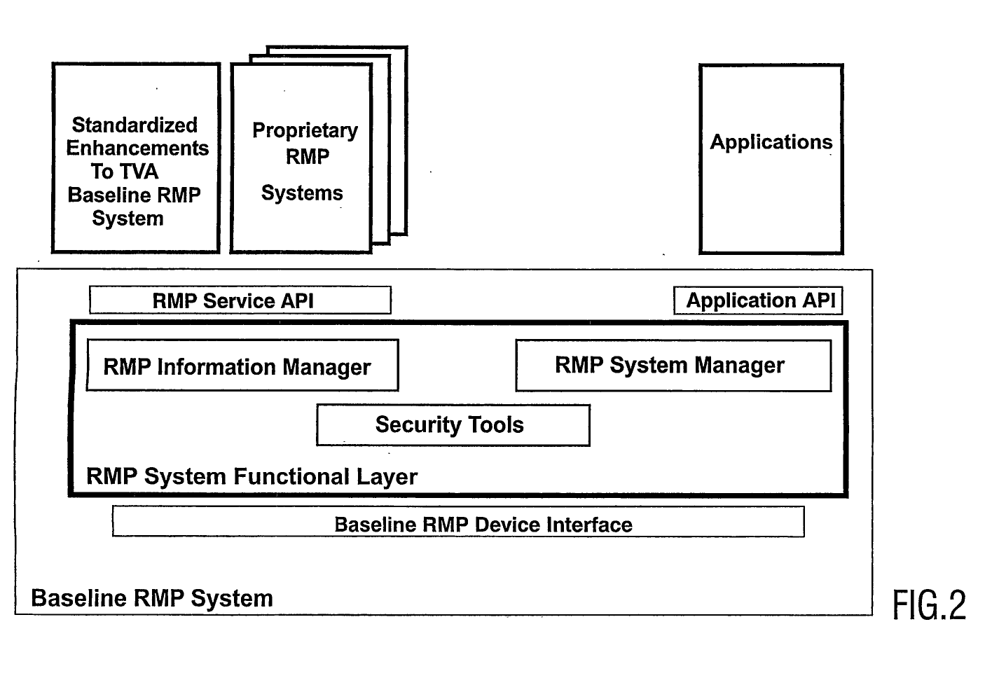

The basic structure of a preferred security framework for Rights Management & Protection (RMP) is illustrated in FIG. 2. This security framework is defined in the TV Anytime Call For Contributions (CFC), see the TV Anytime Website at http://www.tv-anytime.org/cfcs/. In FIG. 2, the following elements are described:
Application API: Allows applications to communicate in an interoperable way with the RMP system.
Application: Software and/or services enabling user access to content and PDR features in accordance with RMP conditions.
Baseline RMP System: The functionality conformant with TV Anytime RMP baseline specification.
Proprietary RMP systems: Proprietary content protection systems interfacing with the TVA RMP baseline system through the RMP service API.
RMP Information Manager: Decides what kinds of actions are allowed on content, e.g. play, copy, move, etc. and may pass cryptographic keys to security tools.
RMP Service API: Allows an RMP system to communicate in an interoperable way with the RMP Baseline security functions.
RMP System Functional Layer: Collection of functions implementing the Baseline System.
RMP System Manager: Manages operation of the Baseline System.
Security tools: Possibly contains: de-scrambler, watermark detector/embedder, signature verifier, etc.
Standardized enhancements to TVA baseline RMP system: optional TVA standardized extensions to the TVA RMP Baseline system.
TVAF RMP Baseline Device Interface: A secure communications layer between TVA compliant devices

This document provides a solution for the following system elements:
Application API
RMP Service API
Inter-device communication
   Application API

A standardized API is needed when software from third parties have to be developed. So, a standardized application API is required only on platforms with this requirement. Examples of such platforms are platforms that support downloaded applications. Only on such devices an application API is required.

The DAVIC CA-API (DAVIC (Digital Audio-Visual Council), 1998. DAVIC 1.4 specification, http://ww.davic.org/) is proposed as application API. The DAVIC CA API addresses the majority of the functionality required for using protected content from an application. It is however likely that some extensions are required to address issues related to storage and networks.

RMP Service API

The RMP Service API allows an RMP system to communicate in an interoperable way with the RMP Baseline security functions. The RMP Service API shall consist of the subset of methods from OPIMA as given in this section. In the following sections the OPIMA Methods for the RMP API are grouped according to functionality. For OPIMA, see OPIMA (Open Platform Initiative for Multimedia Access), Specification Version 1.1, 2000, incorporated herein by reference. http://www.cselt.it/opima/.

Access to Content

This part reflects the interface definition of the ‘Abstract Access to Content’ interface, section 3.3.4.7 of the OPIMA standard. Via this interface an application can indicate the desired action on the content.

In OPIMA the RMP system has little control over the stop-action of the content when the RMP decides that access to the content is no longer allowed (e.g. because a content rule transfers a change in access rights). The only mechanism that is available for the RMP system is to send a wrong decryption key to the OPIMA Virtual Machine (OVM). It depends on the implementation of the OVM whether this action will result into a crash of the system. A more graceful shutdown of the content access is necessary as an additional method.

The following methods shall be used for access to content:
installCallbackContentAccess
AbstractContentAccess
replyToContentAccess

Optionally, the following additional method can be used:
stopContent(ContentId)
   Access to Rules/Keys

This part reflects the interface definition of the ‘Abstract Access to Rules’ interface, section 3.3.4.8 of the OPIMA standard. Via this interface the RMP system can indicate what rules/rights data it desires to receive.

The following methods shall be used for user interaction:
obtainUserRules
obtainContentRules
newRules
updateContentRules

Optionally, the following additional method can be used:
addContentRules
   Smartcards

This part reflects the interface definition of the ‘Smart Cards’ interface, section 3.3.4.6 of the OPIMA standard. The RMP system can access smart cards via this system and send/receive standard ISO 7816 APDUs.

The following methods shall be used for smart card interaction:
addCTListener
removeCTListener
cardInserted
cardRemoved
getSlotId
isCardPresent
openSlotChannel
closeSlotChannel
getATR
reset
sendAPDU
   Encryption & Decryption

This part reflects the interface definition of the ‘Encryption and Decryption Engines’ interface, section 3.3.4.3 of the OPIMA standard. The RMP system can control via this interface both the content cryptography as well as cryptographic actions on miscellaneous data.

The following methods shall be used for encryption and decryption:
queryEncryptionAlgorithms
encrypt
initencryption
updateEncryptionKeys
stopEncryption
decrypt
initDecryption
updateDecryptionKeys
stopDecryption
   Signatures

This part reflects the interface definition of the ‘Signature Engines’ interface, section 3.3.4.4 of the OPIMA standard. Via this interface, the RMP system can check and generate both signatures over the content as well as signatures over miscellaneous data.

The following methods shall be used for signatures:
querySignatureAlgorithms
verifySignature
verifyContentSignature
generateSignature
generateContentSignature
   Watermarks

This part reflects the interface definition of the “Watermark Engine” interface, section 3.3.4.5 of the OPIMA standard. Via this interface, the RMP system can detect and embed watermarks in the content.

The following methods shall be used for watermarks:
queryWatermarkAlgorithms
extractWatermark
stopWatermarkExtraction
msertWatermark
stopWatermarklnsertion
   Access to RMPs

This part reflects the interface definition of the ‘Abstract Access to OPIMA Peers’ interface, section 3.3.4.9 of the OPIMA standard. Via this interface baseline systems can interact with each other.

The following methods shall be used for interaction between RMP systems:
openConnection
closeConnection
addConnectionListener
sendMessage
newConnection
receiveMessageFromPeer
   User Interaction

This part reflects the interface definition of the ‘User Interface’, section 3.3.4.1 of the OPIMA standard. Via this interface the user can exchange information with the RMP system.

The following methods shall be used for user interaction:
sendMessageToUser
receiveMessageFromUser

The receiveMessageFromUser method only allows for the transfer of strings of characters between the RMP system and the user. The RMP system has no control over the formatting and presentation of the information. To support such formatting in the receiveMessageFromUser method, the MessageText value(s) shall be according to the Common Interface high-level MMI messages as standardized in CENELEC EN 50221: 1997, Common Interface for Conditional Access and other Digital Video Decoder Applications; and CENELEC R 206-001: 1997, Guidelines for the implementation and Use of the Common Interface for DVB 15 Decoder Applications.

Application Interaction

This part reflects the interface definition of the ‘Abstract Access to Applications’, section 3.3.4.10 of the OPIMA standard. This interface defines a transparent bit channel between the application and the RMP system.

In the DVB framework multiple applications and multiple RMP systems can be present. Therefore this interface will be enhanced with some specific methods to enable the interoperability between applications and RMP systems for some basic functionality.

The following methods shall be used for application interaction:
installCallbackApplication
replyMessage
receiveMessageFromApplication

The following extension is optional:

The receiveMessageFromApplication method shall contain the additional Message Type ‘QUERY_ENTITLEMENT’. As response to this message type the RMP system shall return the list of available entitlements for the current user, via the standard ‘replyMessage’.

Life Cycle Control

This part reflects the interface definition of the ‘Life-cycle Control’ interface, section 3.3.4.11 of the OPIMA standard.

The following methods shall be used for life cycle control:
initialize
terminate
update
remove
   TVAF RMP Baseline Device Interface

The Device Interface should provide a secure communications layer between TVA compliant devices. Elements related to this interface include the relation of the security framework to other system elements like home networking middleware (e.g. UPnP, HAVi and Jini). Furthermore, authentication of compliant devices and secure communication between these devices are addressed by the Baseline Device Interface. The device interface has been defined as an extension of OPIMA toward home networks.

Baseline RMP System

The Baseline RMP System provides the TVA system with a standardized copy protection system. Because it is standardized and mandatory in each device implementing the framework, any device implementing the Baseline RMP System can access content protected by this RMP System. Furthermore, it is very important that the baseline system is simple and easy to implement. This is of prime importance, as the baseline system will also have to be supported by small inexpensive mobile devices.

The Baseline RMP System, like any RMP System consists of two parts: the key management and the content encryption. Using the system explained in the next section, this allows proprietary RMP system that use the baseline content encryption scheme to exercise end-to-end control. Although a Baseline RMP system is not proposed, any RMP system proposed should be compatible with the OPIMA RMP Service API.

A simple baseline system should support at least the content rules: copy_free, copy_one_generation, copy_no_more. As this Baseline RMP system will be present in each compliant device, the content encryption algorithm should be cheap, easily accessible and robust. As AES fulfils all these requirements, it is preferred to use the Advanced Encryption Standard (AES) as the baseline content encryption scheme.

Basline Device Interface

In the previous section the OPIMA system was introduced. OPIMA provides a security framework for applications and Digital Rights Management (DRM) systems to interoperate. In this section the OPIMA system is expanded to operate within a home network. For an introduction to the use of DRM in home networks, see F. L. A. J. Kamperman, S. A. F. A. van den Heuvel, M. H. Verberkt, Digital Rights Management in Home Networks, Philips Research, The Netherlands, IBC 2001 conference publication vol. I, pages 70-77.

A home network can be defined as a set of devices that are interconnected using some kind of network technology (e.g. Ethernet, IEEE 1394, BlueTooth, 802.11b, . . . ). Although network technology allows the different devices to communicate, this is not enough to allow devices to interoperate. To be able to do this, devices need to be able to discover and address the functions present in the other devices in the network. Such interoperability is provided by home networking middleware (HN-MW). Examples of home networking middleware are Jini, HAVi, UPNP, AVC.

The use of network technology and HN-MW changes a set of individual devices into one large virtual device. From a HN-MW point of view, a network can be seen as a set of functions that can be used and connected. Such a system provides a user with capabilities to address any content or service from anywhere in the home network.

HN-MW can be defined as a system that provides two services. It allows an application in the network to locate devices and functions in the network. Furthermore, some kind of remote procedure call mechanism (RPC) defines how to use these functions. From a HN-MW point of view, systems related to handling secure content appear in several ways. Certain functions in the network require access to protected content. Other functions in the network provide functionality that can be used by the elements in the network handling content security. Furthermore, security frameworks like OPIMA can use the HN-MW to locate each other and communicate in an interoperable way.

Security Frameworks and Home Networks

This subsection discusses this last option: how to use a home networking middleware to locate and communicate between security frameworks. In this case, the security framework can be represented as a function in the home network. This allows security functions to locate and address other security functions in the network.

Using this approach, we can locate other security frameworks and use their functionality. This is sufficient for normal applications. In the case of applications addressing secure content, one requires that the content remains secure and the secrets that protect the content can not be intercepted. Furthermore, proof is required that the other security device can be trusted.

Such functionality is preferably provided by a secure authenticated channel (SAC). When a SAC is created both parties authenticate each other and create a secure channel of encrypted messages. This allows security frameworks that want to communicate with each other to do this securely. When several security devices are present in a network, the set of SACs between them can be seen as a virtual private network (VPN).

Within such a VPN, again devices and functions need to be located and addressed. So a home network middleware (HN-MW) is needed to operate within the VPN. As such functionality is already present in the system (the HN-MW used to locate the security device), it can be reused within the scope of the VPN.

In order to do so, the security framework will have to be able to send and receive messages and should implement a method that allows messages to be sent to it using HN-MW techniques (see Appendix E).

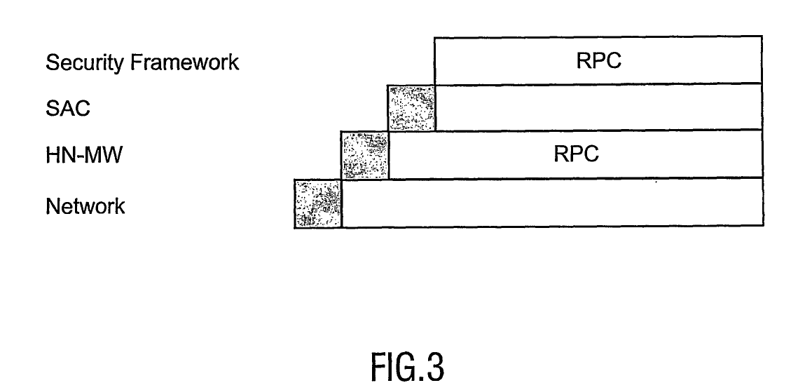

To explain this in more detail, FIG. 3 describes a message sent from one security framework to another. In this figure, the grey blocks on the left indicate the message header, the white blocks indicate the message body. The network message contains the HN-MW message that is a remote procedure call (RPC) on the security function.

The data of the remote procedure call is the body of the message to be processed by the SAC. Although a SAC could be defined for each HN-MW standard we propose to use one SAC, preferably SSL (RFC 2246), for all HN-MW standards. The data element of the SAC is again a remote procedure call but this time on the functions of the security function. In this case it is an OPIMA function call. The HN-MW message is then incorporated into a network message and transmitted over the home network.

The solution allows security frameworks to locate each other and communicate and is independent of HN-MW and network technology. Of course, the SAC can also be incorporated into the HN-MW or network technology. Is this case the picture would change a little but the functionality would remain.

Authentication and Trust

In order for devices to use protected content in a secure way, the RMP systems and security frameworks in a network need to trust each other. A trusted device can be expected to work within the parameters set by the standard. In order to do this a trusted third party needs to check a device before providing the keys needed for authentication.

This is implemented using a two step approach: an RMP system authenticates the TVAF, and then TVAFs authenticate each other. This prevents that the RMP system has to authenticate each TVAF in the system and has to support all kinds of HN-MW specifics.

When an RMP system is embedded in the device, authentication of the security framework may not be required as they can trust each other. This has the advantage that the (time consuming) authentication of the security framework by the RMP system can be skipped.

Using Remote Tools

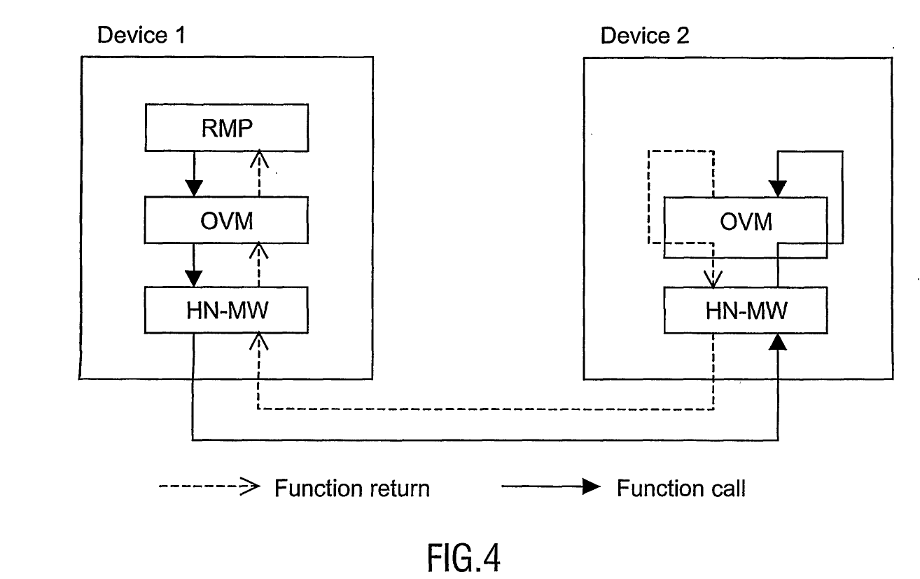

As explained above in the section on security frameworks and home networks, a VPN is created between TVAFs. This can be seen as one large TVAF. The VPN can be used to locally provide tools of an remote TVAF. In this case, calls are made using RPC calls on the public interface of the other TVAF. An example of such a call in the context of OPIMA OVMs (which can be used as TVAFs) is indicated in FIG. 4. On device 2, the call and return are routed through the OVM to symbolize that the RPC with the SAC is extracted and called.

Another option for TVAFs to provide tools implemented elsewhere in the network is to provide tools directly available on the HN-MW. Probably the best example of such a tools is a smart card reader. The communication with smart cards is already protected by the RMP system and can be accessed over an unprotected channel.

This set-up allows TVAFs to provide the tools in the HN-MW and tools available on other TVAFs in the VPN. From a performance point of view it is advisable to use of local tools when available. Networked tools are presented using the normal OPIMA API. Of course a TVAF implementation can choose to provide networked tools and is in no way obliged to do so.

Content Decoding, Streaming and HN-MW

When accessing content in a networked environment, the content may have to be streamed/transported from the source to other devices. In most cases this requires some QoS support from the network. The way to set-up a connection in a network and to manage the QoS is heavily dependent on the network technology. Typically such streams are created and stopped using mechanisms defined in the HN-MW.

As content can always be intercepted on the device interface, any content leaving an TVAF should be protected. Typically this is done using some kind of encryption. The RMP system maintains control of the content by controlling access the keys that allow descrambling of the content. Content shall only leave the domain of TVA devices protected by some kind of RMP system. Furthermore, each transfer of content from one RMP system to another is controlled by the RMP system. In this way RMP system remains in control of what happens to the content.

Distributed Content Accesses

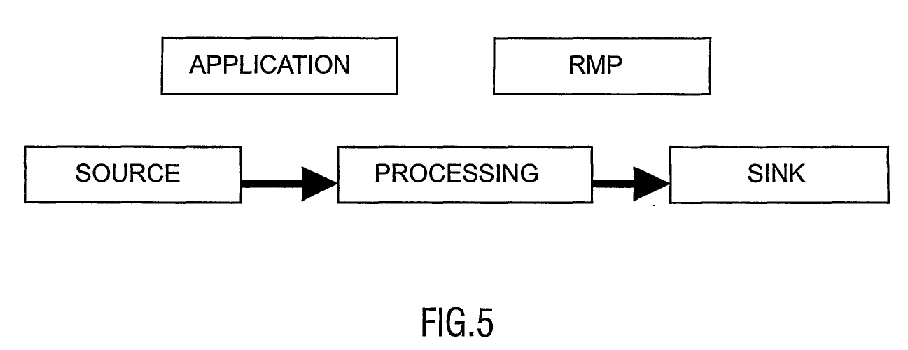

Another way to use home networking middleware is to implement content accesses using elements implemented on other devices. An example of how to realize such a distributed content access can be seen in FIG. 5. In this example, the following roles can be distinguished:
Source, the source of the content.
Sink, the sink of the content.
Processing, one or more processing functions can be present in the streaming path. A processing function is a function in which some operation is done on the content.
Application, the application connecting the different HN-MW functions and starting the content access. Note that this ‘application’ is in reality the implementation of the DVB-MHP API (or any other similar API).
RMP, the RMP system controlling the content.

In a distributed content access, each of these roles can be located on a different device.

HN-MW and OPIMA Compartments

A multitude of content formats and RMP systems exist. To prevent having to model and support each possible option, OPIMA uses the concept of compartments. According to OPIMA, a compartment is a class of OPIMA enabled devices that share some common elements in their RMP interfaces and/or architectural components. For example, DVB can be considered as a compartment, which in turn contains other compartments defined by specific RMP system. Compartments can be hierarchical. That is, a compartment can contain sub-compartments.

A compartment defines the different system elements and tools available within this compartment. As an RMP system operates within the scope of an compartment, it knows what tools and systems it can expect. Examples of elements defined within the scope of compartments are encryption algorithms and rule filters.

Within the scope of HN-MW, the compartments are used to define the networked functions to be available in the IHDN that will be interconnected using HN-MW. These security functions are defined in a compartment and can be implemented as an separate function with the HN-MW or they can be incorporated in another function (e.g. a tuner may hold a rules filter, a display a descrambler). Using compartments security functions can be defined in such a way that content can only be available on the device interface protected by some kind of RMP system.

Protected Content and Metadata

In order to access content, the RMP system protecting the content has to be known. In the traditional set-up, the content is available in the device, which is also holding the security components. In a network this does not need to be the case anymore. So the application requires means to determine the what RMP system is used to protect the content. This is additional information that is needed on top of already existing metadata like content format.

In an ideal world the content would only have to be processed when the content is rendered. However in some cases the RMP system may require some operations to be performed on the content. Examples of such operations are key replacement and re-encryption. These operations are dependent on the operation that is required on the content and should be known to the application. An example of such occasions is when is copied, the rules associated with the content may change (copy_one_generation→copy_no_more). Only when the application knows that some operations are required for a certain operation, can these operations be incorporated in the streaming path. Other elements that should incorporated in the streaming path specific rules filters.

So, the application will have to know which security functions to incorporate in the streaming path. The application can learn of these functions from the metadata. The content metadata will contain a list for each content access type of the operations that should be included.

The security functions that are needed depend on the type of access that is required to the content. In other words, they depend on the Purpose of the content access. Within OPIMA a set of purpose is defined. This set has been extended to fit the full set of content accesses from a network point of view.

Three main classes of purposes are defined. A full list of a purposes is given in Appendix B below.
RELEASE, this purpose class manages transfers of content from one RMP system to another. Next to the purpose class, the purpose of the content within the other RMP system is indicated.
RECEIVE, this purpose class indicates content is received from another RMP system.
ACCESS, the purpose class handles access to the content within one RMP system. Next to the purpose class, the purpose is indicated in more detail.

A release of content is needed when the rights of the content are transferred from one RMP system to another, typically this requires changing the rules in the content and possibly also re-encryption. Access like content (format) transcoding, trick play and picture improvement processing does not change the content and should be allowed within the scope of the RMP system. Such functionality would typically be part of a processing function.

So, the metadata related to RMP systems should hold the following information:
Compartment definition (see Appendix C).
RMP definition (see Appendix C).
List of purposes with for each purpose the URN of the security function that is required.
Possibly some compartment specific information.

In order to recognize the security functions present in a function within the HN-MW, each related function in the HN-MW will implement methods indicating this.

Security Functions and Frameworks

At this point a streaming graph holding all required security functions can be created, so this specific content session can be started. One or more of such sessions can be chained to involve all elements needed to access the content.

In OPIMA such a session is represented by a so-called ContentId, which uniquely identifies one of the streams within the TVAF. In a networked environment it becomes important to be able to define such a ContentId with a definition which makes each Contentid unique. This is done by replacing the OPIMA ContentId with a structure containing the following values:
tvaffd, an unique identifier of the TVAF.
contentAccessId, a unique identifier identifying this session within the scope of this TVAF.
streamid, a number indicating the stream within this session that is referred to.

In appendix C at C.1.5 this structure is represented in IDL (ContentSessionId).

The combination of tvafld and contentaccessld uniquely identifies this session. Using this information the TVAFs of the security functions in the network can register with the master TVAF to receive messages related to this content access. So first a new session has to be created. Appendix A contains an example of the definition of the internal methods that can be used to create a session.

Using the tvaffd and ContentAccessId, the security functions involved in this content access can register themselves with the TVAF where the content access is started (Master TVAP). This is done using the attachToContentAccess method on the HN-MW API of the security function. When this method is call, the TVAF of the security function will register itself with the Master TVAF.

Upon registration, the Master TVAF will call the registration TVAF, confirm the registration and indicate the purpose associated with this content access. The TVAF will treat the content of this content access within the scope of this Purpose.

When all security functions are registered, the session can be started. The session is started by starting streaming in the home network and then indicating that access to the content is required. Streaming should start first because rules filters located at other devices than the source device need access to the content. This requires streaming to be starting. To support proprietary extensions, at any point the application can communicate directly with RMP system (see appendix A at A.3 and A.4).

At this point, the session can be started. The TVAF will contact the RMP system, rules will be filtered and access to the content will be granted or denied.

Distributed Content Access and RPCs

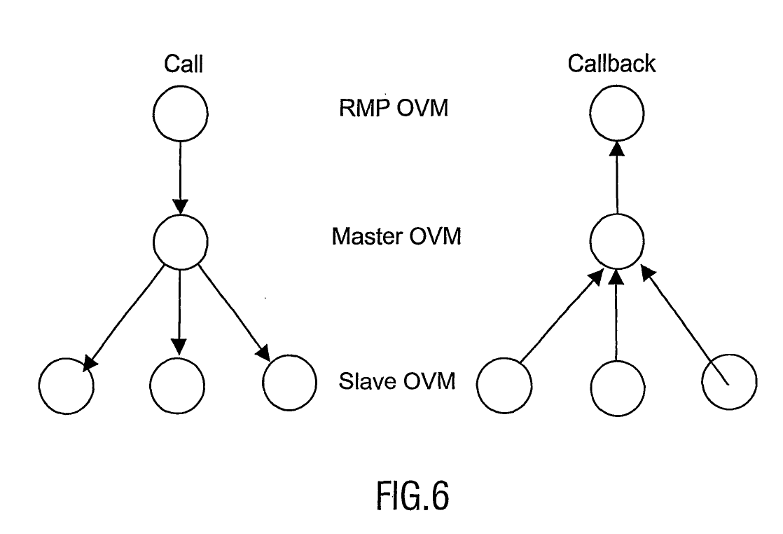

In an RMP system, local and distributed content accesses should be handled in the same fashion. In order to use the OPIMA APIs irrespectively of networked access, some guidelines on RPC handling are required. RPC calls are managed according the system indicated in FIG. 6.

All RMP system calls, indicated as “Call”, are rerouted by the Master OVM to all OVMs registered with the session. The responses of all calls are combined and a return value is indicated in the callback to the RMP system.

Two types of (remote procedure) calls can be determined, those related to content accesses and the calls that are using tools. Content access related calls use a Contentld to relate to the content access. Normal, not Content Access related calls regarding tools are called local if available, otherwise remote. Content access related calls are handled using the following guidelines:
1. If the call is a RPC, handle it locally and return the result.
2. If the call is local, and if the content access of this call is local, call the function on all registered TVAFs (also locally if this TVAF is part of the stream).
3. If the call is local but the content access of this call is not, call the Master TVAF holding the content access.

The master slave nature of this solution simplifies the communication, as the different TVAFs do not need to know which functionality is located at what TVAF.

Appendix A: Application Services API

The DAVIC CA API serves as the application API within the scope of this document. In order to implement this API, internally in the device hosting this API, some specific information has to be passed to the TVAF. This is done using internal proprietary APIs that do not need to be specified. The following (informative) methods give an example of the methods that are used to start, stop and control content accesses attachToContentAccess

This method registers its TVAF with the TVAF managing the indicated content access so it will receive any related RPCs. All values are indicated by the TVAF when a content access is started.

A.1 Applications Services

A.1.1 createContentRelease

Create a session with the TVAF with the intention of releasing content to another RMP system.

| | Values |
|---|---|
| Input Parameters | |
| SourceRMP | string (TVAF URL of a |
| The URL of the RMP protecting the content. | RMP system). |
| TargetRMP | string (TVAF URL of a |
| The URL of the RMP the content will be | RMP system). |
| released to. | |
| Purpose | |
| An identifier of the purpose to access content. | |
| Output Parameters | |
| ContentAccessId | A positive integer value |
| A unique identifier of this session within this | |
| TVAF. | |
| Return Variable | |
| Result | An integer value. |
| Either an identification of the connection or an | Success if Result == 0 |
| error code | Failed if Result < 0 |

A.1.2 createContentAccess

Create a session with the TVAF with the intention of accessing content.

| | Values |
|---|---|
| Input Parameters | |
| RMP | string (TVAF URL of a |
| The URL of the RMP protecting the | RMP system). |
| content. | |
| Purpose | |
| An identifier of the purpose to access | |
| content. | |
| Output Parameters | |
| ContentAccessId | A positive integer value |
| A unique identifier of this session within | |
| this TVAF. | |
| Return Variable | |
| Result | An integer value. |
| Either an identification of the | Success if Result == 0 |
| connection or an error code | Failed if Result < 0 |

A.1.3 createContentReceive

Create a session with the TVAF with the intention of receiving content from another RMP system.

| | Values |
|---|---|
| Input Parameters | |
| sourceRMP | string (TVAF URL of a RMP |
| The URL of the RMP protecting the | system). |
| content. | |
| targetRMP | string (TVAF URL of a RMP |
| The URL of the RMP the content will be | system). |
| released to. | |
| Purpose | |
| An identifier of the purpose to access | |
| content. | |
| Output Parameters | |
| ContentAccessId | A positive integer value |
| A unique identifier of this session within | |
| this TVAF. | |
| Return Variable | |
| Result | An integer value. |
| Either an identification of the | Success if Result == 0 |
| connection or an error code | Failed if Result < 0 |

A.1.4 startContentSession

Start this session

| | Values |
|---|---|
| Input Parameters | |
| ContentAccessId | A positive integer value. |
| A unique identifier of this | |
| session within this TVAF. | |
| Listener | Method address |
| callback function that delivers | |
| the TVAF response to the | |
| application | |
| Return Variable | |
| Result | 32 bit integer, that can be either positive |
| Either an identification of the | or negative. A positive value indicates |
| connection or an error code | session ID that can be used by the |
| | application to match subsequent |
| | asynchronous responses from the TVAF. |
| | Negative values indicate that an error |
| | occurred and the reason of failure |
| Asynchronous Responses | |
| startContentSessionResponse | Indicates if this content session is possible. |

A.1.5 stopContent

Stop a content access, release or receive.

| | Values |
|---|---|
| Input Parameters | |
| TVAFId | A positive integer value |
| An unique identifier of the TVAF | |
| calling TVAF. | |
| ContentAccessId | A positive integer value |
| The unique identifier of the content | |
| session the calling TVAF request | |
| attach to. | |
| Return Variable | |
| Result | An integer value. |
| Either an identification of the | Success if Result == 0 |
| connection or an error code | Failed if Result < 0 |

A.2 Application Services Listener
A.2.1 startContentSessionResponse

This asynchronous response is issued by the TVAF to the application to notify that a certain event has occurred; it can be used for synchronisation purposes.

| Input Parameters | Values |
|---|---|
| SessionID | Same value previously returned by |
| An identifier provided by the | startContentSession. |
| TVAF which refers to the | |
| action to which this is a | |
| response | |
| Status | SUCCESS if status = 0 |
| Indicates success or failure, and | ErrorCode if status < 0 |
| reasons of failure | |
| Message | An RMP specific string explaining |
| An RMP specific string to be | the status. |
| interpreted by the application. | |

A.3 Application RMP Services
A.3.1 queryRMPSystems

This method allows applications to send messages to the RMP systems installed in the TVAF and to receive answers.

| | Values |
|---|---|
| Input Variables | |
| Listener | Method address |
| callback Method that delivers | |
| the TVAF response to the | |
| application. | |
| Return Variable | |
| Result | An integer value. |
| | Success if Result == 0 |
| | Failed if Result < 0 |
| Asynchronous Responses | |
| indicateRmpList | An array of URNs (strings). |
| List of RMP systems known to | |
| this TVAF. | |

A.3.2 sendMessageToRMP

This method allows applications to send messages to the RMP systems installed in the TVAF and to receive answers.

| | Values |
|---|---|
| Input Parameters | |
| RMPsystemID | An array of bytes containing a unique ID |
| Identification of the RMP | assigned by a registration authority. |
| system to which the | |
| message is addressed. | |
| Message Type | Content Query |
| Identification of the | RMP system proprietary |
| message type | NULL message (to allow an application |
| | register itself as a receiver of messages |
| | without actually sending any message) |
| | Table of values is given in the IDL definition. |
| Message | URL (in case of a content query message) |
| | Data passed to the RMP component. |
| Listener | Method address |
| callback Method that | |
| delivers the TVAF | |
| response to the | |
| application. | |
| Return Variables | |
| Result | 32 bit integer, that can be either positive or |
| | negative. A positive value indicates session ID |
| | that can be used by the application to match |
| | subsequent asynchronous responses from the |
| | TVAF. Negative values indicate that an error |
| | occurred and the reason of failure. |
| Asynchronous Responses | |
| Content query response | Content not available. |
| | String for display to end-user. |
| | Data |

A.4 Application RMP Services Listener
A.4. 1 msgFromRMp

This asynchronous response is issued by the TVAF to the application to notify that a certain event has occurred; it can be used for synchronisation purposes.

| | Values |
|---|---|
| Input Parameters | |
| SessionID | Same value previously returned by either |
| An identifier provided by | sendMessageToRMP. |
| the TVAF which refers | |
| to the action to which | |
| this is a response | |
| Status | SUCCESS if status = 0 |
| Indicates success or failure, | ErrorCode if status < 0 |
| and reasons of failure | |
| Message | Either |
| An RMP specific string | An RMP specific string (in reply to a |
| to be interpreted by the | sendMessageToRMP request) or |
| application | A list of alternative sets of RMP systems that |
| | are needed by the content in order for the |
| | TVAF to perform the intended “purpose”, |
| | associated with the indication of their current |
| | status in the TVAF (present/missing). RMP |
| | systems are identified by RMP system IDs, |
| | as defined above (in reply to a queryTVAF |
| | request). |

A.4.2 indicateRmpList

This asynchronous response is issued by the TVAF to the application to notify the list of available RMP systems.

| Input Parameters | Values |
|---|---|
| SessionID | Same value previously returned by either |
| An identifier provided by | createContentAccess, createContentRelease, |
| the TVAF which refers to | createContentReceive, getRMPSystem, |
| the action to which this | sendMessageToRMP or queryTVAF. |
| is a response | |
| RMPsystemList | An array of URNs (strings). |
| List of RMP systems | |
| known to this TVAF. | |
| Result | SUCCESS if status = 0 |
| Indicates success or failure, | ErrorCode if status < 0 |
| and reasons of failure | |

Appendix B: Purposes

The following purposes have been defined.

| Purpose class | Sub class | Description |
|---|---|---|
| RELEASE | RENDER | Release the content to another RMP system, |
| | | only allowing rendering on a device |
| | | (no storage). |
| | MOVE | Transfer this content completely to another |
| | | RMP system. |
| | COPY | Transfer a copy of this content to another |
| | | RMP system. |
| RECEIVE | | Receive content from another RMP system. |
| ACCESS | STORE | Store this content on some storage device. |
| | RENDER | Render the content. |
| | EDIT | Make a copy of the content and edit it. |
| | DELETE | Delete the content. |
| | PROCESS | Process the content without changing the |
| | | rights (eg. bitrate or content transcoding). |
| OTHER | | Other accesses defined in the compartment. |

Appendix C: TVAF API Related to HN-MW USE
C.1 TVAF Network Services
C.1.1 getTVAFId

Returns the TVAF id of this TVAF.

| | Values |
|---|---|
| Output Parameters | |
| tvafId | A positive integer value |
| An unique identifier of this TVAF. | |
| Return Variable | |
| Result | An integer value. |
| Either an identification of the | Success if Result == 0 |
| connection or an error code | Failed if Result < 0 |

C.1.2 registerWithContentSession

Registers the calling TVAF with the indicated content session

| | Values |
|---|---|
| Input Parameters | |
| tvafId | A positive integer value |
| An unique identifier of the | |
| calling TVAF. | |
| contentSessionId | A positive integer value |
| The unique identifier of the | |
| content session the calling TVAF | |
| request attach to. | |
| Return Variable | |
| Result | An integer value. |
| Either an identification of the | Success if Result == 0 |
| connection or an error code | Failed if Result < 0 |

C.1.3 unRegisterWithContentSession

Unregisters the calling TVAF with the indicated content session

| | Values |
|---|---|
| Input Parameters | |
| TVAFId | A positive integer value |
| An unique identifier of the | |
| calling TVAF. | |
| contentSessionId | A positive integer value |
| The unique identifier of the | |
| content session the calling TVAF | |
| is no longer interested. | |
| Return Variable | |
| Result | An integer value. |
| Either an identification of the | Success if Result == 0 |
| connection or an error code | Failed if Result < 0 |

C.1.4 contentSessionRegistered

Confirmation of registration by a Master TVAF. The purpose indicates the purpose of related to this content access. The TVAF shall treat the content within the scope of this purpose.

| | Values |
|---|---|
| Input Parameters | |
| TVAFId | A positive integer value |
| An unique identifier of the | |
| Master TVAF. | |
| contentSessionId | A positive integer value |
| The unique identifier of the | |
| content session within the Master | |
| TVAF. | |
| Purpose | |
| The unique identifier of the | |
| content session within the Master | |
| TVAF. | |
| Return Variable | |
| Result | An integer value. |
| Either an identification of the | Success if Result == 0 |
| connection or an error code | Failed if Result < 0 |

C.1.5 contentSessionStopped

Indication to other TVAFs that a content session has been stopped.

| | Values |
|---|---|
| Input Parameters | |
| TVAFId | A positive integer value |
| An unique identifier of the | |
| Master TVAF. | |
| contentSessionId | A positive integer value |
| The unique identifier of the | |
| content session within the Master | |
| TVAF. | |
| Return Variable | |
| Result | An integer value. |
| Either an identification of the | Success if Result == 0 |
| connection or an error code | Failed if Result < 0 |

C.2 IDL

The IDL code of the previous methods is:

```
// generic structs
enum Purpose { RELEASE_RENDER, RELEASE_MOVE,
RELEASE_COPY, RECEIVE, ACCESS_STORE, ACCESS_{—}
RENDER, ACCESS_EDIT, ACCESS_DELETE, ACCESS_{—}
PROCESS, OTHER};
typedef sequence <octet, 16> TvafId;
struct ContentId {
TvafId tvafId;
    long contentSessionId;
    long streamId
} ;
// TVAF network related interfaces
interface TvafNetworkServices {
    long getTvafId( out TvafId tvafId );
    long registerWithContentSession( in TvafId tvafId,
in long contentSessionId );
    long unRegisterWithContentSession(in TvafId tvafId,
in long contentSessionId );
    long contentSessionRegistered( in TvafId tvafId, in
long contentSessionId, Purpose p );
}
```

Appendix D: TVAF URLS and URNS
D.1 Uniform Resource Locator (URL) Definition

For use in TVAFs, the following URL definition is given:

RMP systems
tvaf:://<network_address>/<TVAFid>/ipmp/<rmp_id>
Applications
tvaf:://<network_address>/<TVAFid>/app/<app_id>
Tools
tvaf::// <network_address>/<TVAFid>/tool/<tool_id>

In these URLs the different fields have the following meaning:

tvaf::, indicates the messages are sent over the SAC.

<network_address>, the address of the device hosting the TVAF.
<TVAF_id>, the id of the TVAF.
<RMP_id>, the id of the RMP module.
<app_id>, the id of the application
<tool_id>, the id of the tool

### EXAMPLES

tvaf:://130.130.120.4/34535/ipmp/1213
tvaf:://130.130.120.4/34535/app/113
tvaf:://130.130.120.4/34535/tool/12234

D.2 Uniform Resource Name (URN) Definition

The TVAF system URNs are defined as:

Compartments:
tvaf:://<compartment_source>/compartment
Security Functions:
tvaf:://<compartment_source>/compartment/<function>

In these URNs the different fields have the following meaning:
<compartment_source>, the name (intemet style) of the body that defined the compartment.
<function>, the name of this specific function in this compartment.

### EXAMPLES

tvaf:://org.dvb/mpeg2
tvaf:://org.dvb/mpeg2/sink
tvaf:://org.dvb/mpeg2/receive
tvaf:://org.dvb/mpeg2/source
tvaf:://org.dvb/mpeg2/processor

Appendix E: Methods on HN-MW Methods
E.1 TVAFAPI

TVAFs are represented in the HN-MW as a separate Method. The following methods shall be available on such function.

E.1.1 newMessage

A new message for this TVAF has been received.

| | Values |
|---|---|
| Input Parameters | |
| Message | An array of bytes containing the |
| The message that is sent to this | SAC message. |
| TVAF. | |
| Return Variable | |
| Result | An integer value. |
| Either an identification of the | Success if Result == 0 |
| connection or an error code | Failed if Result < 0 |

E.2 Security Function API

The following methods shall be available on functions in the HN-MW supporting security functions.

E.2.1 getSecurityFunctions

This method indicates the URNs of the security functions (Appendix D) supported by this HN-MW function

| | Values |
|---|---|
| Output Parameters | |
| securityFunctionUrns | An array of strings (URNs). |
| The URN of the security | |
| functions of the compartments | |
| supported by this HN-MW | |
| function | |
| Return Variable | |
| Results | An integer value. |
| Either an identification of the | Success if Result == 0 |
| connection or an error code | Failed if Result < 0 |

E.2.2 attachToContentAccess

This method registers its TVAF with the TVAF managing the indicated content access so it will receive any related RPCs. All values are indicated by the TVAF when a content access is started.

| | Values |
|---|---|
| Input Parameters | |
| TVAFId | An integer value. |
| The TVAF managing this content | |
| access. | |
| ContentAccessId | An integer value. |
| A unique ID of this content access | |
| within the TVAF that is managing this | |
| content access. | |
| Return Variable | |
| Result | An integer value. |
| Either an identification of the | Success if Result == 0 |
| connection or an error code | Failed if Result < 0 |

Appendix F: Abberviations

Below is a list of abbreviations as used in this document, with their intended meaning.
AES Advanced Encryption Standard
APDU Application Protocol Data Unit
API Application Programming Interface
CFC Call for Contribution
DAVIC Digital Audio & Visual Council
DVB Digital Video Broadcasting
HAVi Home Audio Video interoperability
HN-MW Home Networking Middleware
ISO International Organization for Standardisation
MMI Man Machine Interface
MPEG Moving/motion Pictures Expert Group
OVM OPIMA Virtual Machine
QoS Quality of Service
RMP Rights Management and Protection
RPC Remote procedure call
SAC Secure Authenticated Channel
TLS Transport Layer Security protocol
TTP Trusted Third Party
TVA TV-Anytime
TVAF TV-Anytime Framework
UPnP Universal Plug and Play
VPN Virtual Private Network

It should be noted that the above-mentioned embodiments illustrate rather than limit the invention, and that those skilled in the art will be able to design many alternative embodiments without departing from the scope of the appended claims. For instance, while in the above OPIMA is used, other security frameworks can of course be substitued. For example, the MPEG-4 IPMP extensions could be used in a similar way.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer.

In the device claim enumerating several means, several of these means can be embodied by one and the same item of hardware. The mere fact that certain measures are recited in mutually different dependent claims does not indicate that a combination of these measures cannot be used to advantage.

1. A conditional access system comprising a plurality of devices interconnected in a network, the devices being grouped in a first group and a second group, the devices of the first group operating in accordance with a first security framework and the devices of the second group operating in accordance with a second security framework, each device operating using a particular middleware layer, said middleware layer being arranged to authenticate another middleware layer of another device, said middleware layer being authenticated by the security framework in accordance with which the device operates.

2. The system of claim 1, in which a device from the first group can execute a function of the second security framework by making a remote procedure call (RPC) to the middleware layer of a device from the second group

3. The system of claim 2, in which the RPC is transmitted to the device from the second group over a secure authenticated channel (SAC).

4. The system of claim 1, in which the devices are granted permission to access content in accordance with a particular class of purposes, there being defined a set of such classes, each class comprising a number of conditional access operations or purposes.

5. The system of claim 4, in which a first class from the set comprises the operations RENDER, MOVE and COPY.

6. The system of claim 5, in which a second class from the set comprises the operations STORE, RENDER, EDIT, DELETE and PROCESS.

7. The system of claim 6, in which the PROCESS operation is authorized independent of any restrictions on rights associated with the content.

8. A method of allowing a device to conditionally access a piece of content, in which the device is granted permission to access content in accordance with a particular class of purposes, there being defined a set of such classes, each class comprising a number of conditional access operations or purposes.

9. The method of claim 8, in which a first class from the set comprises the operations STORE, RENDER, EDIT, DELETE and PROCESS.

10. The method of claim 9, in which the PROCESS operation is authorized independent of any restrictions on rights associated with the content.
